(19) United States
(12) Patent Application Publication
(10) Pub. No.: US 2026/0052409 A1
(43) Pub. Date: Feb. 19, 2026

(54) TECHNOLOGIES FOR MEASUREMENT GAP OPERATIONS

(71) Applicant: Apple Inc., Cupertino, CA (US)

(72) Inventors: Yuqin Chen, Beijing (CN); Peng Cheng, Beijing (CN); Behrouz Aghili, San Diego, CA (US); Haijing Hu, Los Gatos, CA (US); Fangli Xu, Beijing (CN); Ralf Rossbach, Munich (DE); Naveen Kumar R. Palle Venkata, San Diego, CA (US); Zhibin Wu, Los Altos, CA (US); Shu Guo, Beijing (CN); Xiaoyu Qiao, Beijing (CN); Huarui Liang, Beijing (CN); Qiming Li, Beijing (CN)

(73) Assignee: Apple Inc., Cupertino, CA (US)

(21) Appl. No.: 19/271,595

(22) Filed: Jul. 16, 2025

Related U.S. Application Data
(60) Provisional application No. 63/684,222, filed on Aug. 16, 2024.

(51) Int. Cl. H04W 24/08; H04W 76/28

(52) U.S. Cl. CPC H04W 24/08; H04W 76/28

(57) ABSTRACT

The present application relates to devices and components including apparatus, systems, and methods for measurements gap configuration and operation.

### CROSS-REFERENCE TO OTHER APPLICATION

This application claims priority to U.S. Provisional Patent Application No. 63/684,222, for “TECHNOLOGIES FOR MEASUREMENT GAP OPERATIONS” filed on Aug. 16, 2024, which is herein incorporated by reference in its entirety for all purposes.

### TECHNICAL FIELD

This application relates generally to communication networks and, in particular, to measurements gap configuration and operation.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a configured information element in accordance with some embodiments.

FIG. 3 illustrates a timing diagram in accordance with some embodiments.

FIG. 4 illustrates another network environment in accordance with some embodiments.

FIG. 5 illustrates a signaling in accordance with some embodiments.

FIG. 6 illustrates an operation flow/algorithmic structure in accordance with some embodiments.

FIG. 7 illustrates another operation flow/algorithmic structure in accordance with some embodiments.

FIG. 8 illustrates another operation flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

In Release 15 (Rel-15) of the 3GPP standards, measurement gaps are developed to enable UEs to perform necessary measurements across different frequencies and Radio Access Technologies (RATs). Measurement gaps are categorized into different types to address various measurement needs and capabilities of the UE. These types include per-UE gaps, independent gaps for different frequency ranges (FRs) (for example, FR1 and FR2), and gapless inter-RAT measurements.

The Rel-15 per-UE gap is a type of measurement gap designed to monitor all frequency layers, including intra-frequency, inter-frequency, and inter-RAT frequency layers across all frequency ranges. During this gap, the UE is not required to conduct reception or transmission with the serving cells except for the reception of signals used for Radio Resource Management (RRM) measurements and signals utilized for the random access procedure. This gap type allows the UE to switch frequencies and perform necessary measurements without being burdened by ongoing data transmission tasks.

Another type of measurement gap in Rel-15 is the per-FR gap, which is used for monitoring intra-frequency, inter-frequency cells, and inter-RAT frequency layers within a specific frequency range. Similar to the per UE gap, the UE is not required to maintain reception or transmission with the serving cells in the corresponding frequency range, except for the reception of signals used for RRM measurements (also referred to as layer 3 (L3) measurements) and the random access procedure. This type of gap is particularly useful for UEs operating in specific frequency bands, allowing them to perform their measurement activities within those bands without interference from other tasks.

In addition to these gap types, there is also the gapless inter-RAT measurement, particularly for long-term evolution (LTE) to new radio (NR) measurements. This type of measurement, defined in Release 18 (Rel-18), extends the scope to include LTE to NR measurements in both FR1 and FR2 without requiring a measurement gap. The gapless inter-RAT measurement capability allows UEs to perform measurements on NR cells while maintaining active communication with the LTE serving cells, eliminating the need for predefined measurement gaps and providing continuous data transmission and reception.

In Release 16 (Rel-16) of the 3GPP standards, significant advancements were introduced to optimize the measurement gap configurations, particularly focusing on dynamic and flexible approaches to manage measurement requirements. Two key developments in this release include the concept of Dynamic NeedForGap and inter-frequency measurements without the need for predefined measurement gaps.

The Dynamic NeedForGap mechanism allows the network to dynamically configure the measurement gap requirements based on the specific conditions and requirements of the UE. The network can specify the target band that should report the NeedForGap to the UE. Upon receiving this configuration, the UE may evaluate its current Carrier Aggregation (CA) or Dual Connectivity (DC) configuration to determine whether a measurement gap is necessary for the specified target band. The UE then reports the measurement gap requirement information back to the network in response to a configuration message via the Radio Resource Control (RRC) protocol. This dynamic approach allows for more efficient utilization of measurement gaps, ensuring that they are only employed when absolutely necessary, thereby reducing unnecessary interruptions in data transmission.

Additionally, Rel-16 introduces the inter-frequency measurements without the need for predefined measurement gaps (interFrequencyMeas-NoGap). This enhancement is particularly beneficial for UEs with advanced RF capabilities that can perform measurements on different frequencies without interrupting data transmission and reception on the serving cell. In scenarios where the UE can manage inter-frequency measurements concurrently with ongoing communication tasks, the need for traditional measurement gaps is eliminated. This capability may allow the UE to continuously monitor signal quality and perform measurements without interrupting its service, thereby enhancing overall network performance and user experience.

For instance, in a scenario where the network configures a UE with the Dynamic NeedForGap mechanism, the network might specify a target frequency band for which the UE needs to assess the necessity of a measurement gap. Based on its current CA/DC configuration, the UE may determine If a gap is needed. The UE may report this requirement back to the network, which can then configure the appropriate measurement gaps accordingly. Conversely, if the UE is capable of performing inter-frequency measurements without gaps, it can continue its data transmission uninterrupted while still conducting the necessary measurements on the target band.

The enhancements introduced in Rel-16, including Dynamic NeedForGap and

interFrequencyMeas-NoGap, provide greater flexibility and efficiency in managing measurement gaps. These advancements allow UEs to perform essential measurements with minimal disruption to ongoing communication tasks, thereby improving cellular networks' overall efficiency and performance. For example, a UE utilizing the interFrequencyMeas-NoGap capability can seamlessly switch frequencies for measurements while maintaining continuous data transmission, thus ensuring uninterrupted service quality and optimal network utilization.

Release 17 (Rel-17) of the 3GPP standards introduced enhancements to optimize measurement gap configurations, particularly focusing on advanced capabilities and flexible gap management. These enhancements include IndependentGapConfig-maxCC, Pre-Measurement Gaps (Pre-MG), Network Controlled Small Gaps (NCSG), Concurrent Gaps, FR2 Uplink Gaps, Multi-SIM (MUSIM) Gaps, and parallelMeasurementGap-r17 in Non-Terrestrial Networks (NTN).

The IndependentGapConfig-maxCC feature introduces a new UE capability to indicate whether a per UE gap should be applied instead of a per-FR gap, even if the UE supports independent gaps. This capability is particularly important when baseband processing is heavy, as the UE may not be able to enable per-FR gap measurements, which require simultaneous data transmission on one FR and measurement on another FR. By allowing the UE to use a per-UE gap, it can manage its resources more efficiently and ensure accurate measurements without overloading the baseband processing.

The Pre-Measurement Gap (Pre-MG) mechanism in Rel-17 allows for the on/off status of Pre-MG to be determined by the relationship between the active Bandwidth Part (BWP) and Measurement Object (MO). The activation, deactivation, or switching of BWP can change the on/off status of Pre-MG. There are two approaches to determine the status of Pre-MG, depending on the UE's capability: network-controlled Pre-MG activation/deactivation and UE autonomous Pre-MG activation/deactivation. In the network-controlled approach, the on/off status is determined by a flag configured in the active BWP. For CA, if any active BWP indicates ON, Pre-MG is ON. In the UE autonomous approach, Pre-MG is OFF if all MOs are gapless according to MO and BWP configuration; otherwise, Pre-MG is ON. The criteria for determining the status are defined in TS38.133 v.18.8.0 (2024 Jul. 17).

The Network Controlled Small Gap (NCSG) feature allows RF1 to be interrupted due to RF2 tuning to perform measurements. The reporting framework for NCSG follows the same framework as dynamic NeedForGap, ensuring consistency and efficiency in gap management.

Concurrent gaps are another advancement in Rel-17, allowing up to two per-UE measurement gaps to be configured for UEs that are not capable of per-FR measurement gaps. Specific gap combination configurations can be reported separately for UEs capable of per-FR measurement gaps, allowing for more flexible and efficient measurement operations.

Rel-17 also introduces FR2 Uplink Gaps and multi-subscriber identify module (SIM) (MUSIM) Gaps, which cater to specific use cases and operational needs. The FR2 Uplink Gap allows for efficient management of uplink transmissions in the FR2 frequency range, while MUSIM Gaps accommodate the activities of another SIM in multi-SIM devices, ensuring minimal disruption to ongoing communication tasks.

The parallelMeasurementGap-r17 feature in Non-Terrestrial Networks (NTN) allows for up to four Synchronization Signal/Physical Broadcast Channel Block (SSB)-based RRM measurement timing configurations (SMTCs) in parallel per carrier and for a given set of cells. This configuration uses propagation delay differences and ephemeris information between the serving cell and neighboring cells. Additionally, two parallel gaps can be configured for the same carrier to cover the four SMTCs, enhancing the measurement capabilities in NTN environments.

In Release 18 (Rel-18) of the 3GPP standards, several advancements have been introduced to further refine and optimize the management of measurement gaps. These enhancements include features such as no-gap operations with or without interruption, finer differentiation in NeedForGap reporting, extended gap usage for Layer 1 (L1) and Layer 2 (L2) triggered mobility (LTM) measurements and LTE measurements without gaps.

One of the features of Rel-18 is no-gap operations, which can occur with or without interruption. This feature allows UEs with advanced RF capabilities to perform measurements on neighboring cells without the need for predefined measurement gaps, thereby maintaining continuous communication with the serving cell. This no-gap operation is particularly beneficial for enhancing the efficiency of measurement processes and reducing the latency associated with traditional gap-based measurements. By allowing measurements without interruptions, the network can ensure that the UE can gather necessary data seamlessly, improving the overall user experience and network performance.

Another significant advancement in Rel-18 is the finer differentiation in NeedForGap reporting. This refinement allows the UE to report measurement gap requirements more precisely and granularly. The UE can provide detailed information about its need for measurement gaps based on specific conditions and scenarios, enabling the network to make more informed decisions about gap configuration. This finer differentiation helps in optimizing the utilization of measurement gaps, ensuring that they are employed only when necessary and minimizing unnecessary interruptions in data transmission.

Rel-18 also extends the usage of measurement gaps for L1 and L2-triggered mobility (LTM) measurements. This extension allows for more efficient and accurate measurement processes at the physical layer, which is crucial for maintaining the quality of service and seamless connectivity. By incorporating measurement gaps into L1 and L2 measurements, the network can enable the UE to perform necessary measurements with reduced impact on ongoing communication tasks, thereby enhancing the overall efficiency of the measurement process.

Additionally, Rel-18 introduces the capability for LTE measurements without gaps. This feature enables UEs to perform measurements on LTE cells while maintaining active communication with the serving cell, eliminating the need for predefined measurement gaps. This capability is particularly beneficial for UEs operating in environments with mixed LTE and NR deployments, as it allows for seamless and continuous measurement processes without disrupting ongoing communication. By enabling gapless LTE measurements, Rel-18 ensures that the UE can gather necessary measurement data efficiently and without interruption, contributing to improved network performance and user experience.

Measurement gaps may be prioritized over normal communication, except for the Random Access Channel (RACH) procedure.

In Rel-17, concurrent gaps were introduced, wherein the network configures multiple measurement gaps to enable UEs to conduct measurements efficiently without significant disruption to ongoing communication. Building on this, Rel-18 introduced the MUSIM gap feature, which allows UEs equipped with multiple SIM cards to request a preferred gap priority from the network. This means that a UE can indicate its preference for which measurement gaps should take precedence based on its operational needs, enhancing the efficiency of measurement processes for devices operating with multiple SIMs. By allowing the UE to request and prioritize measurement gaps, the network can better manage the allocation of these gaps, ensuring that the most critical measurements are performed with minimal impact on communication services.

Measurement gaps can be shared between L1 and L3 measurements, as well as between intra-frequency and inter-frequency measurements. The gap pattern is designed based on the reference signal pattern. The starting point of gap utilization at the UE and network levels depends on the measurement initiation criteria, such as the S-measure. There are issues when the UE does not differentiate which frequencies to measure and which to skip, even with the introduction of the measurement sequence (measSequence-r18). The network assumes that the Rel-15 measurement gap is enabled as long as it is configured. For Pre-Measurement Gaps, the network applies the same principle as the UE to determine the gap on/off status based on the configured carrier aggregation and active Bandwidth Part.

The determination of whether a gap is needed by the UE is based on several principles. The spectrum span of the serving cell's RF chain must cover the Measurement Objects (MeasObjects) to determine whether gapless measurement can be performed. Rel-15 gapless measurement is possible if the active BWP covers the MeasObject. A switch in BWP can lead to a change in the need for a gap. In Rel-18, if the UE's RF chain covers the entire spectrum span of a carrier, it can cover a MeasObject not in the active BWP. Additionally, any spare RF chain can cover the MeasObject. The serving cell configuration depends on RF capability (number of RF chains) and the UE's baseband processing capability.

Current 3GPP gaps are categorized based on processing capability and RF chains. For example, IndependentGapConfig-maxCC, indicates the maximum number of configured (not activated) serving cells. Other gap types include independent gaps, interFrequencyMeas-NoGap, Pre-MG, concurrent gaps, and gapless measurements. Both NeedForGap and Network Controlled Small Gaps (NCSG) can operate with or without interruption. It is important to note that even if no gap is needed, TS38.133 defines the scheduling availability of the SMTC, prohibiting the network from scheduling the UE during measurement at SMTC under certain conditions.

Measurement gap capability is provided in the UE capability and RRCConfigurationComplete based on the current CA/DC configuration, such as needforgap/NCSG reporting. Updating measurement gaps based on NeedForGap/NCSG reporting incurs long latency due to the handshake required between the UE and the network. Multiple measurement gaps/types are configured by the RRC, with gap activation/deactivation potentially impacted by L1/L2 commands (e.g., Pre-MG on/off status changes due to BWP switching). The UE can suggest the measurement gap pattern via UE assistance information (UAI), e.g., for MUSIM purposes. The network halts scheduling/data transmission during measurement gap occasions after configuring the gap, as it is unaware of which measurement gap the UE actually uses. Exceptions include IndependentGapConfig-maxCC, where the network knows the actual CA/DC configuration of the UE, and Pre-MG, where the network applies the same principle as the UE to decide the on/off status of Pre-MG.

Various observations highlight the complexity and challenges of managing measurement gaps: 1) different gap features were introduced in different phases to satisfy various motivations; 2) changes in measurement gap configuration based on NeedForGap/NCSG may occur frequently, necessitating a new handshake procedure with each update to CA/DC configuration and MeasObject(s); 3) gap determination involves multiple factors, including UE RF chain capability, baseband capability, and current serving cell configuration; 4) excessive and early initiation of gaps can lead to a reduction in UE throughput; 5) the network stops data scheduling during all configured gap occasions, leading to unnecessary data interruption, which is critical for delay-sensitive data; 6) besides measurement gaps, 3GPP allows UEs to perform measurements during idle durations (Discontinuous Reception (DRX) off duration), which is up to UE implementation.

Based on the observations above, enhancements to the operation of measurement gaps are desired. It may be beneficial for all parameters influencing gap determination to be considered from the outset. These parameters include the UE's RF capabilities, the frequencies that need to be measured, the SSB index, and the current state of baseband processing. By considering these factors, the network can ensure that measurement gaps are configured to optimize the UE's ability to perform necessary measurements without unnecessary interruptions to communication services.

Another consideration is the dynamic selection of measurement gaps from a set of preconfigured gaps. This selection could be based on a comprehensive assessment of all relevant factors, such as the specific Measurement Objects (MeasObjects), the type of service being provided, and the current processing status of the UE. By dynamically selecting the most appropriate measurement gap for the given conditions, the network can enhance the efficiency and accuracy of measurements while minimizing disruption to ongoing communication.

Additionally, embodiments provide a mechanism to choose between using DRX off periods and measurement gaps for performing measurements. This selection may be guided by the specific requirements of the measurement task and the operational context of the UE. For instance, in scenarios where the UE is in a DRX-OFF period, performing measurements during this idle time may be more efficient than disrupting active communication with a measurement gap.

Furthermore, the network may need to know the starting point of RRM measurements. This knowledge can be used to coordinate and schedule measurement gap operations. By being aware of the exact starting time of the measurements, the network can ensure that the UE performs necessary measurements during periods that minimize disruption to data transmission and reception. This precise timing allows the network to optimize resource allocation and scheduling, thereby supporting seamless and efficient measurement operations without negatively impacting the quality of service. Additionally, knowing the starting point of RRM measurements enables the network to manage interference and load balancing, ensuring that measurements are conducted under optimal conditions for accuracy and reliability.

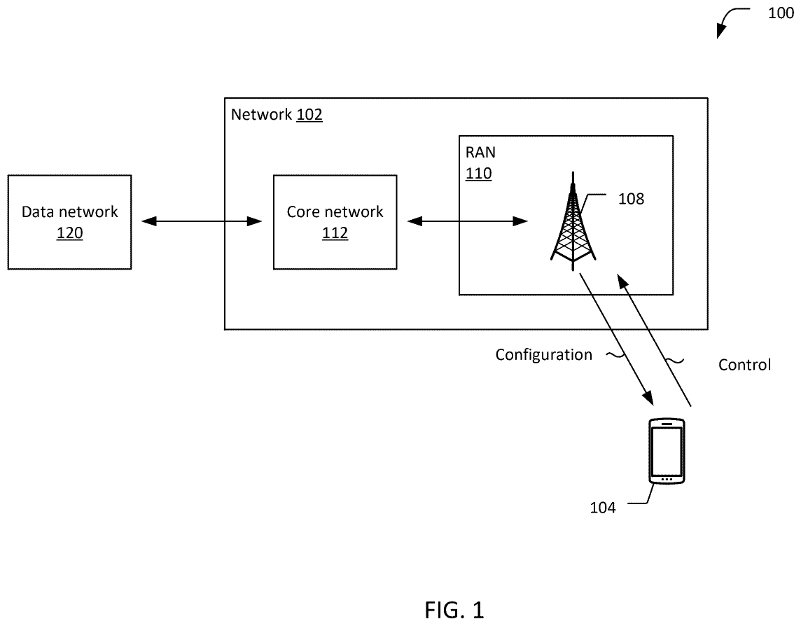

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system, a Sixth Generation (6G) system, or a later system. The base station 108 may provide user plane and control plane protocol terminations toward the UE 104.

The network environment 100 may further include a core network 112. For example, the core network 112 may comprise a Fifth Generation Core network (5GC), a Sixth Generation core network (6GC), or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions. Core network 112, RAN 110, and base station 108 may collectively be referred to as network 102.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

In some instances, network 102 may control the configuration of measurement gaps. Network 102 may send configuration signaling to UE 104 to configure the UE 104 with measurement gaps (MGs). Measurement gaps allow UE 104 to temporarily suspend communication with the serving cell and perform measurements on neighboring cells. Measurement gaps would allow UE 104 to collect data in a timely manner without interfering with ongoing communication sessions.

Measurement gaps may be used for L3 or L1 measurements during a measurement gap. UE 104 may temporarily interrupt data transmission in the serving cells to measure the signals of neighboring cells. UE 104 may switch to the frequencies or channels used by the neighboring cells to receive and measure signals (e.g., reference signals or other transmitted signals).

Once UE 104 performs the measurement, it may create measurement reports based on the measurements and report them as control information to base station 108. In some instances, network 102 may initiate cell reselection or handover procedures. In other instances, UE 104 may initiate cell reselection or handover procedures. Handover may be triggered when UE 104 is in a connected state, and cell reselection may be triggered when UE 104 is in an idle state.

In some embodiments, support for simplified and unified measurement gap configuration is introduced to improve measurement gap management. This approach aims to streamline the configuration process, making it easier for both the network 102 and the UE 104 to manage and apply measurement gaps. Adopting a unified configuration framework can reduce the complexity of managing multiple gap types and configurations, which may lead to consistent measurement operations across different network environments and UE capabilities.

In some embodiments, dynamic control to activate or deactivate measurement gaps is introduced. Dynamic control allows both UE 104 and network 102 to activate and apply measurement gaps based on real-time conditions and requirements. For instance, network 102 can dynamically instruct UE 104 to initiate a measurement gap when specific conditions are met, such as changes in the radio environment or service requirements. Conversely, UE 104 can autonomously activate a measurement gap when it detects the need for measurements, ensuring that gaps are used when necessary.

In some embodiments, flexible rules are introduced to determine the priority between measurement and data transmission during measurement gaps. In this flexible approach, data transmission is not always deprioritized or interrupted during the measurement gap, particularly for critical or low-latency data transmissions. This flexibility allows important data to be transmitted even during measurement activities, thereby balancing the need for accurate measurements with the requirement to meet quality of service (QoS) requirements, e.g., latency requirements.

In some embodiments, mechanisms are introduced for alignment on the selected or applied measurement gap between UE 104 and network 102. UE 104 may determine whether measurement gaps should be initiated based on several factors or operational conditions, including the latency requirements of the current service and the S-Measure principle determination for the selected Measurement Objects (MeasObjects). Two options are considered for proper alignment: 1) UE 104 indicates to network 102 once a measurement gap is initiated, allowing network 102 to be aware of and coordinate around the measurement activities; or 2) the network 102 may explicitly command the UE 104 to turn on a measurement gap, thereby enabling network-initiated measurements. This alignment allows both UE 104 and network 102 to have a clear and coordinated understanding of when and how measurement gaps are applied, enabling efficient measurement operations.

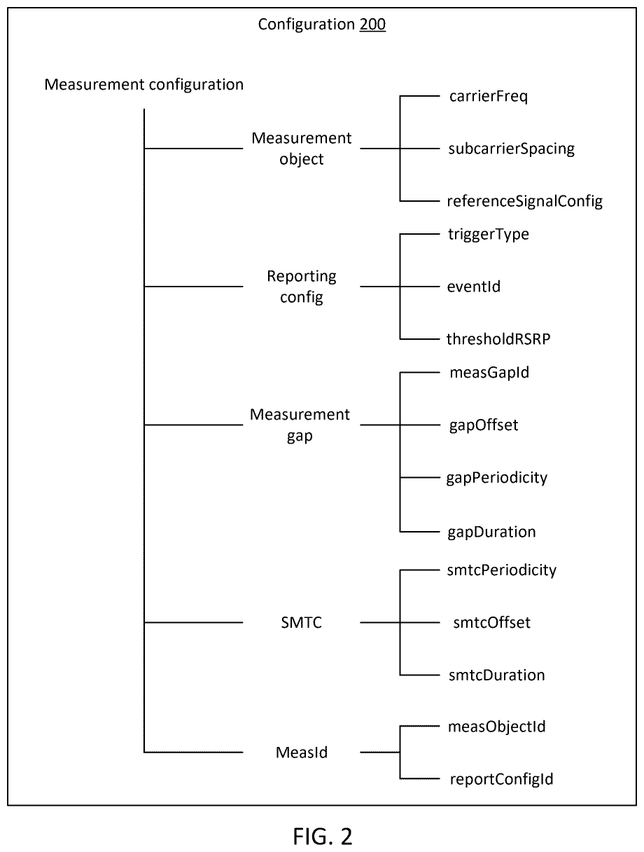

FIG. 2 illustrates a configuration 200 in accordance with some embodiments. Configuration 200 may include measurement configuration. Measurement configuration may configure the UE 104 to perform measurement operations on neighboring cells while maintaining communication with the serving cell. Measurement configuration may include components such as, for example: measurement object configuration, reporting configuration, measurement gap configuration, SMTC configuration, and measurement identity (MeasId) configuration.

The measurement object may specify the parameters for the frequencies that UE 104 is to measure. It may include carrier frequency (carrierFreq), subcarrier spacing (subcarrierSpacing), and reference signal configuration (referenceSignalConfig). These parameters define the specific frequencies and the configuration of reference signals that UE 104 is to monitor to assess the signal quality of neighboring cells. For example, base station 108 may use RRC signaling to configure the measurement object by sending an RRCReconfiguration message containing the carrier frequency and subcarrier spacing details, specifically using the MeasObject information element as specified in 3GPP TS 38.331 v. 18.2.0 (2024 Jul. 11). This allows the UE 104 to gather accurate and relevant data across different frequency bands and subcarrier spacings for informed decision-making regarding handovers or cell reselections.

The number of measurement objects that can be configured depends on capabilities and network configuration of the UE 104. UE 104 may handle multiple measurement objects simultaneously, enabling support for measurements across different frequencies and RATs. The ability of the UE 104 to manage measurement objects may be directly linked to its capabilities, which may be defined during the capability exchange process with the network. During this process, UE 104 may inform network 102 of its measurement capabilities, including the number of measurement objects it can support and the types of measurements it can perform.

Once UE 104 performs the measurements as per the configured measurement objects, it may report the results to network 102. This measurement reporting can be event-triggered, such as when a certain threshold is crossed or periodic, depending on the reporting configuration. Reporting may be done via Radio Resource Control (RRC) signaling messages, which include the measured values and the corresponding measurement objects. The network configures the reporting criteria, including what events trigger a report and the periodicity of reports. This ensures network 102 receives timely and relevant measurement information to make informed decisions on handovers, cell reselection, and other radio resource management tasks.

Measurement objects may be used for various purposes in cellular networks. For instance, measurements of neighboring cells assist the network in deciding when and where to handover UE 104 to allow uninterrupted connectivity. In idle mode, measurements may used by UE 104 to select the best serving cell. Additionally, network 102 can optimize resource allocation and power control strategies by monitoring signal quality and interference levels. Measurement reports also provide valuable data for network planning and optimization, aiding operators in improving coverage and capacity.

For example, the network may configure a measurement object for UE 104 to measure a neighboring cell on a different frequency. The object includes parameters such as the carrier frequency, measurement bandwidth, and reference signal configuration (e.g., CSI-RS). UE 104 may tune to the specified frequency during the configured measurement gaps and perform measurements based on the configured reference signals. When specific conditions are met, such as the signal strength crossing a threshold, the UE may report the measurement results to network 102. The report may include metrics like reference signal receive power (RSRP) and reference signal received quality (RSRQ). Based on this data, the network may decide to initiate a handover, adjust power levels, or take other actions to optimize the UE's connectivity and overall network performance.

Reporting configuration may configure the criteria and conditions under which UE 104 reports its measurement results back to the network. It includes trigger type (triggerType), event identifier (eventId), and threshold for RSRP (threshold RSRP). The trigger type may specify the conditions that prompt UE 104 to send a measurement report, such as periodic or event-based reporting. The event identifier may define the specific events that trigger the report, for example, when a neighboring cell's signal strength (e.g., RSRP) exceeds a certain threshold. The threshold RSRP sets the minimum signal strength level required to generate the report. For example, base station 108 may configure the reporting criteria through an RRCReconfiguration message, specifying that the UE should report measurements when the signal strength of a neighboring cell exceeds a set threshold, using the ReportConfig information element as described in 3GPP TS 38.331.

Measurement gap configuration may define the intervals during which UE 104 may perform measurements on neighboring cells. It may include measurement gap identifier (mcasGapId), gap offset (gapOffset), gap periodicity (gapPeriodicity), and gap duration (gapDuration). The measurement gap identifier may identify the gap configuration, while the gap offset specifies the starting point of the gap within a given time frame. The gap periodicity may define how often the measurement gaps occur, and the gap duration may indicate the length of each gap. During this period, the UE temporarily suspends its communication with the serving cell to perform measurements on neighboring cells. For example, base station 108 may configure these parameters via RRC signaling by sending an RRCReconfiguration message that includes details about the gap offset, periodicity, and duration, using the MeasGapConfig information element according to 3GPP TS 38.331. These parameters allow the UE to temporarily suspend communication with the serving cell to perform necessary measurements without significant disruption to ongoing data transmission.

The measurement gap pattern may be referred to a combination of several parameters that together define the measurement gaps. Key parameters defining measurement gap pattern may include measurement gap length or duration, measurement gap periodicity, measurement gap timing advance (TA), and measurement gap offset.

In a typical configuration, network 102 may use a gap pattern index to simplify the configuration process. For example, a MeasGapConfig with a gap pattern of GP0 and a gapOffset of 10 may specify that the UE 104 should use the predefined pattern GP0, which has specific values for gap length and repetition period as defined by the 3GPP standard.

When UE 104 reports its capabilities to the network, it may include information like supported gap patterns (e.g., GP0, GP1) and custom parameters if the UE 104 supports custom configurations. This information may allow network 102 to configure UE 104 with a measurement gap configuration. If the network 102 configures a measurement gap using a pattern index, the UE 104 uses the predefined (e.g., in 3GPP TSs) set of parameters associated with that index. Alternatively, if network 102 uses detailed parameters, UE 104 configures its measurement gaps according to the specified values. In some embodiments, UE 104 may determine the pattern index and inform network 102 of the selected pattern index. In some embodiments, UE 104 may determine a detailed, customized gap pattern by selecting values for different parameters and informing network 102 of the configuration of the customized measurement gap pattern.

SMTC configuration may specify the timing parameters related to the SSB measurements. It may include SMTC periodicity (smtcPeriodicity), SMTC offset (smtcOffset), and SMTC duration (smtcDuration). The SMTC periodicity may determine how frequently the SSB measurements are performed; the SMTC offset may define the time offset for the measurement start, and the SMTC duration may specify the length of the measurement window.

For instance, base station 108 may configure the SMTC parameters using an RRCReconfiguration message, detailing the periodicity and timing offset for the SSB measurements, specifically utilizing the SMTC information element as outlined in 3GPP TS 38.331. This configuration may synchronize the UE's measurements with the SSB transmission schedule of the neighboring cells, allowing accurate and efficient measurement operations.

MeasId configuration may link the measurement object and the reporting configuration, providing a unique identifier for each measurement setup. It may include measurement object identifier (measObjectId) and report configuration identifier (reportConfigId). The measurement object identifier references the specific measurement object parameters, while the report configuration identifier links to the corresponding reporting criteria. For example, the base station uses RRC signaling to configure the MeasId by sending an RRCReconfiguration message that includes the identifiers linking the measurement object to the reporting configuration, using the MeasId information element as specified in 3GPP TS 38.331.

These components of measurement configuration may be interconnected, working together to allow UE 104 to perform necessary measurements accurately and efficiently. The measurement object defines what needs to be measured, the reporting configuration specifies when and how the measurements are reported, and the measurement gap configuration provides the time intervals for conducting the measurements. The SMTC configuration aligns the measurements with the SSB transmission schedule, and the MeasId configuration uniquely identifies each measurement setup, linking the measurement parameters with the reporting criteria. For example, a comprehensive RRCReconfiguration message could integrate all these configurations, allowing the UE 104 to gather and report measurement data effectively, supporting seamless handovers and optimal network performance.

In some embodiments, simplified and unified measurement gap configurations may be used to enhance the flexibility and efficiency of measurement operations. Network 102 may provision and configure UE 104 with multiple MG configurations in simplified and unified measurement gap configuration. Each measurement gap configuration may be designed to accommodate specific measurement requirements. Network 102 may use RRC signaling to configure UE 104 with multiple measurement gaps. These configurations are associated with specific Measurement Objects (MeasObjects) to ensure that the UE can perform the necessary measurements accurately and efficiently.

Network 102 may provision measurement gap configurations for different purposes, such as L1 or L3 measurements. This differentiation allows the UE to perform specific types of measurements based on the requirements of network 102 and the operational context. Additionally, network 102 may configure different measurement gaps for various measurement objects (MeasObjects), such as those operating in FR1 or FR2. This flexibility may allow UE 104 to handle measurements across different frequency ranges and conditions.

Furthermore, the network can define normal gaps and configurations for Network Controlled Small Gaps (NCSG) measurement gap. Normal gaps may allow UE 104 to temporarily suspend communication with the serving cell to perform measurements on neighboring cells. In contrast, NCSG gaps may provide a more granular control, enabling network 102 to manage small gaps for specific measurement purposes. Network 102 can also provide measurement gap configurations for other purposes, such as supporting Multi-SIM operations, where UE 104 may need to perform measurements for multiple SIMs simultaneously.

In some embodiments, the gap identifier (gap ID) and gap type should be indicated to the UE 104. The indication may be implicit or explicit. The gap ID may uniquely identify each measurement gap configuration, while the gap type may specify the nature of the gap, such as whether it is a normal gap, NCSG gap, or another type. Such identification may allow UE 104 to understand and apply the appropriate measurement gap configuration for the given measurement.

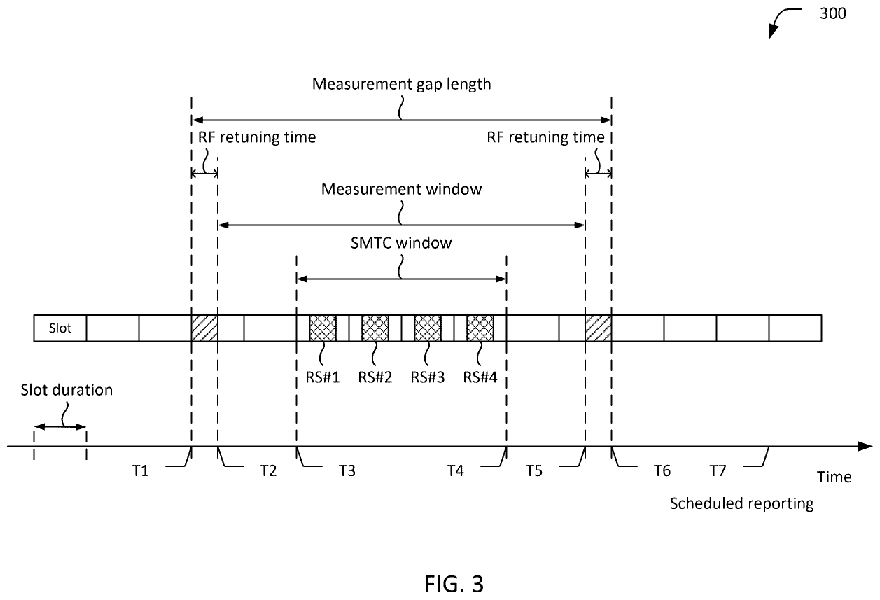

FIG. 3 illustrates a timing diagram 300 in accordance with some embodiments. Timing diagram 300 is an example of the relationship among components of a measurement configuration described above.

Network 102 may configure UE 104 with a measurement gap configuration. At T1, one instance of a measurement gap period starts. The measurement gap may be configured with the measurement gap length of L slots, e.g., L=8 slots in FIG. 3. Thus, the measurement gap ends at T6=T1+L.

In some instances, UE 104 may not be able to perform measurement immediately at the beginning of the measurement period at T1. UE 104 may need some time to reconfigure its RF circuitry to the frequency and cell configurations that will be measured. Similarly, at the end of the measurement gap period, UE 104 may need some time to retune its RF circuitry to the data transmission or reception configuration. This time is captured by RF retuning time in FIG. 3. Between T1 and T2 at the start of the measurement gap period and between T5 and T6 at the end of the measurement gap period, the UE 104 may perform the RF retuning, and during these periods UE 104 may not be able to transmit or receive data nor will it perform any measurements. Therefore, the time between T2 and T5 is the measurement window that is available to UE 104.

Network 102 may configure UE 104 with an SMTC window. Network 102 may configure the SMTC window within the T2−T5 measurement window that is available to UE 104. For example, the SMTC window may start at T3. SMTC window may be configured to have a window length of W slots, e.g., W=4 slots in FIG. 3. Thus, the SMTC window may end at T4=T3+W.

The SMTC configuration may include one or more measurement occasions within the configured SMTC window. Network 102 may configure the transmission of reference signals to overlap with the measurement occasions. For example, UE 104 may measure reference signals (RS) RS #1, RS #2, RS #3, and RS #4 at measurement occasions during the SMTC window.

Network 102 may configure UE 102 with reporting configuration. UE 104 may be configured with a reporting instance at T7. UE 102 may generate and transmit a measurement report to base station 108 at T7.

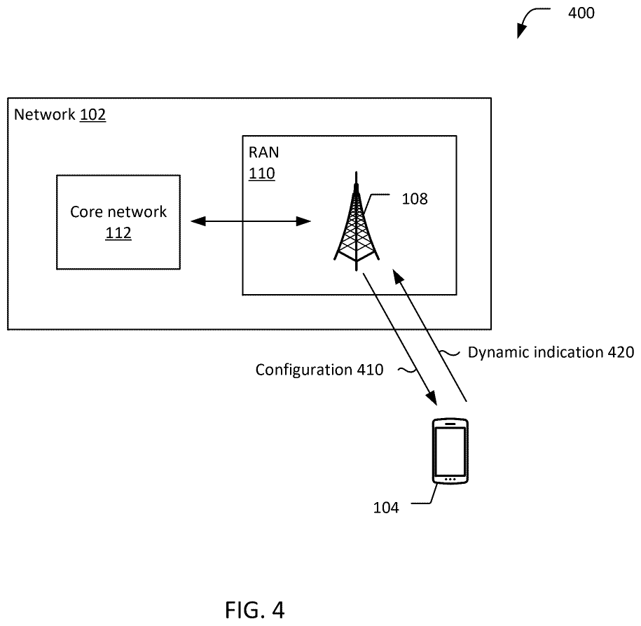

FIG. 4 illustrates another network environment 400 in accordance with some embodiments. Network environment 400 may be an example of network environment 100. In network environment 400, UE 104 may receive measurement configuration (e.g., as described in FIG. 2) through configuration 410.

UE 104 or network 102 may dynamically activate or deactivate measurement gaps based on one or more operational conditions. This approach may allow UE 104 to adapt to varying conditions and requirements. The framework may include three primary options for dynamic gap selection.

Option 1 may enable UE 104 to select the appropriate measurement gap based on its real-time configuration, considering factors such as carrier aggregation or dual connectivity, measurement objects (MeasObjects), service type, and mobility status. If the current gap pattern does not meet the measurement requirements, UE 104 can suggest an adaptation to network 102. For example, when UE 104 in CA/DC mode starts neighbor measurements with a gap, it can inform network 102 about the gap pattern or the affected serving component carriers (CCs). Additionally or alternatively, if UE 104 can use the DRX off period to perform measurements, it may inform network 102 that no measurement gap is activated. Furthermore, if UE 104 only performs measurements on certain frequencies, it may indicate (e.g., via dynamic indication 420) the specific MeasObjects or associated gaps to network 102. Even when a measurement gap is not needed, UE 104 can specify the MeasObjects to be measured in dynamic indication 420, allowing network 102 to apply scheduling restrictions accordingly.

Option 2 allows network 102 to select an appropriate measurement gap for UE 104. For instance, network 102 may initiate a measurement task for supporting mobility, CA, or DC. Instead of configuring the S-measure, network 102 may enable or disable UE 104 neighbor cell measurements based on detected channel quality (RSRQ), issuing commands (e.g., explicit command via configuration 410) that indicate the applied measurement gap and the frequency to be measured. UE 104 may start measurements of configured neighbor cells on the configured frequency and measurement gaps or based on certain events, such as deteriorating RSRP or RSRQ measurements of the serving cell or at specific location/time conditions (e.g., in non-terrestrial-networks NTN). UE 104 may stop measurements upon receiving a deactivation command (e.g., via configuration 410) or when certain conditions are met, such as a handover command or improved serving cell quality (e.g., RSRP or RSRQ measurements). This approach may allow measurement gaps to be used based on real-time operational conditions. S-measurement in this context may refer to a set of measurements used to evaluate the signal quality and strength, e.g., RSRP, RSRQ, or signal-to-interference-plus-noise ratio (SINR).

Option 3 includes omitting the pre-configuration of measurement gaps and allowing UE 104 to decide the gap pattern. The gap pattern may be predefined in the 3GPP TSs, so UE 104 can simply indicate the gap pattern ID to network 102 via dynamic indication 420.

In some embodiments, network 102 may configure UE 104 with a measurement gap configuration index, and when UE 104 applies another configuration, it may indicate the offset value of the new index with the configured index. A variant of this approach may allow UE 104 to switch from a network-configured gap pattern to a UE-decided gap pattern. This method provides UE 104 with the flexibility to manage its measurement gaps dynamically and based on its operational conditions.

Option 4 may include UE 104, indicating its preferred gap configuration compared to network 102, using dynamic indication 420. In some instances, network 102 may provide the final configuration to UE 104. The final configuration may, or may not, correspond to the preferred gap configuration. This collaborative approach may allow both network 102 and UE 104 to negotiate and agree on a measurement gap configuration based on current operation conditions and requirements.

In Options 1 and 3, when UE 104 determines the gap selection or the gap pattern, it may consider measurement requirements (such as the frequency of measurements, the number of samples to acquire, and the duration of measurements). These requirements may vary across different carrier frequencies with different priorities. Additionally, when a gap is determined for one frequency, UE 104 may request multiple gaps to allow one gap for each Transmission Reception Point (TRP).

These dynamic gap selection options may provide a flexible framework for managing measurement gaps. By allowing UE 104 and network 102 to dynamically adjust gap configurations based on real-time needs, the framework may improve measurement performance and resource utilization, ultimately enhancing network reliability and user experience.

In some embodiments, configuration 410 may be an RRC configuration or included in a medium access control (MAC) control element (CE) or a downlink control information (DCI). Dynamic indication 420 may be an RRC signaling or included in a MAC CE or uplink control information (UCI).

In some embodiments, a flexible approach to deciding the priority between measurement and data transmission during measurement gaps (MG) is considered. In some instances, and unlike legacy systems, data transmission is not always deprioritized or interrupted during MG. Instead, the priority between measurement and data transmission on the serving cell may depend on the service type. For instance, high-priority data, such as critical packets, can be prioritized over neighbor cell measurement during the gap. This priority rule may allow packets with low latency requirements or important critical data transmissions to be given precedence over measurements, providing uninterrupted data flow for essential services.

In some embodiments, network 102 may use configuration 410 to configure an occupation rate for high-priority services, pre-determining the actual position for data transmission inside the measurement gap. The occupation rate may determine the proportion of time within a measurement gap allocated for data transmission as opposed to measurements. For uplink (UL) transmissions, UE 104 may autonomously pre-empt some time duration within the gap. For downlink (DL) transmissions, network 102 may indicate the preemption to UE 104 (e.g., via configuration 410) in advance before the gap starts. In some instances, in cases where high-priority data transmission collides with measurement or measurement occasions, UE 104 may perform neighbor cell measurements on frequencies that do not require a gap or during DRX-off durations. This approach may allow for the reallocation of part of the time duration within the measurement gap for data transmission without compromising the quality of measurements.

UE 104 may also shorten the measurement gap and use the remaining time for data transmission. The percentage of the shortened gap can be selected by UE 104 and indicated to network 102 through dynamic indication 420. In some instances, the percentage or amount of the shortened gap may be configured by network 102 via configuration 410. Relevant aspects, such as the UE's capability to shorten the measurement gap and the confidence level of completing the measurement within the shortened gap, may be exchanged between UE 104 and network 102. Furthermore, when high-priority DL traffic arrives at network 102, network 102 may dynamically cancel a measurement gap for a certain time duration, such as a single period of the next PUSCH/PDSCH, via configuration 410 (e.g., L1/DCI or MAC CE).

In some embodiments, preemption rules may be configured by network 102 (e.g., via configuration 410), allowing UE 104 to compare whether data should be prioritized over the measurement gap. For example, network 102 may provision a priority level threshold (X) of Logical Channel (LCH), and for LCH(s) with higher priority than X, UE 104 can prioritize data transmission or reception over the measurement gap.

UE 104 and network 102 may perform alignment on the measurement initiation and measurement gap usage. In one option, UE 104 may indicate (e.g., via dynamic indication 420) to network 102 when the neighbor measurement using the measurement gap is initiated, along with the selected measurement gap or measurement gap configuration.

Additionally or alternatively, UE 104 may indicate (e.g., via dynamic indication 420) its selected subset of the measurement gap occasions for measurement. In some embodiments, the indication of the selected subset can work together with the first option above. In some instances, UE 104 may indicate (e.g., using dynamic indication 420) its preference for a gap pattern or its usage rate among the gap occasions.

Additionally or alternatively, network 102 may command UE 104 (e.g., explicitly using configuration 410) to enable or initiate the neighbor cell measurement with a specific measurement gap configuration. UE 104 may follow the command to start the measurement on the indicated frequency using the gap.

UE 104 may use dynamic indication 420 to indicate the measurement gap stop. In one embodiment, UE 104 may indicate the gap duration together with the initiation indication. In another embodiment, UE 104 may explicitly send one indication for initiation and another indication for stopping the gap usage. In some instances, allocating a lead time for the gap to become effective after receiving the indication from UE 104 may allow the scheduler of network 102 to accommodate changes in DL and UL planning. The lead time may be configurable by network 102 or may be flexible. In some embodiments, the maximum lead time UE 104 may be considered to decide when it needs a gap can be a UE capability. This approach may allow for dynamic management of measurement gaps.

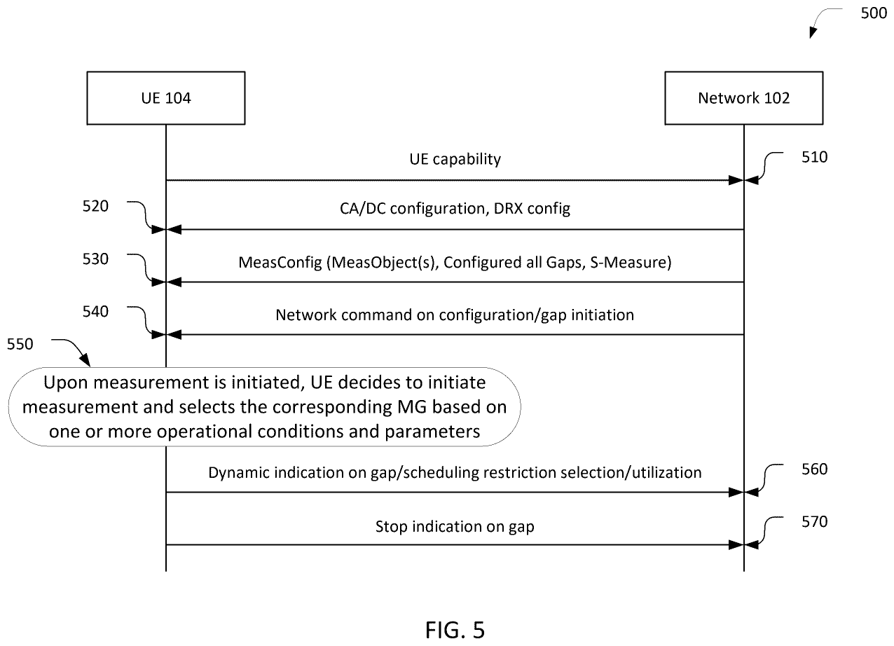

FIG. 5 illustrates a signaling diagram 500 in accordance with some embodiments. At 510, UE 104 may send UE capability information to network 102. Network 102 may determine UE's ability to handle various measurement gap configurations. This includes evaluating the UE's capability to support different types of measurement gaps, such as per UE gap, per Frequency Range (FR) gap, Network Controlled Small Gaps (NCSG), and per Measurement Gap (perMG).

At 520, network 102 may configure UE 104 with the carrier aggregation and dual connectivity configurations, along with DRX settings. Network 102 may configure parameters for each type of gap, such as timing and duration, allowing UE 104 to perform measurements across different frequency ranges and conditions.

At 540, network 102 may generate and transmit commands related to the configuration or activation of serving cells (e.g., serving CCs), BWPs, or the initiation of measurement gaps. These commands are crucial for dynamically managing measurement operations and ensuring that the UE can adapt to changing network conditions. Network 102 can activate specific gaps or configure new ones based on real-time requirements, allowing for efficient measurement processes.

At 550, UE 104 may determine which measurement gap to use based on various criteria, including whether the S-Measure is met, the specific Measurement Objects (MeasObjects) to be measured, and the measurement requirements. UE 104 may consider operational conditions such as the UE's processing status, current service status (whether delay-tolerant or delay-sensitive), location and mobility status, and DRX configuration. For example, if the DRX-off duration is sufficient, UE 104 may determine to perform measurements during the DRX-off periods, reducing the need for additional gaps.

At 560, UE 104 may indicate its selected measurement gaps or scheduling restriction patterns to network 102. This indication can be conveyed via UCI, MAC CE, or RRC messages. UE 104 may provide this information when the actual measurement within the gap starts (e.g., at T2 in FIG. 3) and can optionally indicate the duration of the gap. The indication may allow network 102 to understand the UE's measurement activities and adjust scheduling accordingly.

At 570, UE 104 may indicate the termination of gap usage to network 102. The indication is beneficial when the gap duration is not specified at 560. This indication allows network 102 to resume normal scheduling and data transmission activities to reduce disruption to ongoing communication services due to measurement gaps.

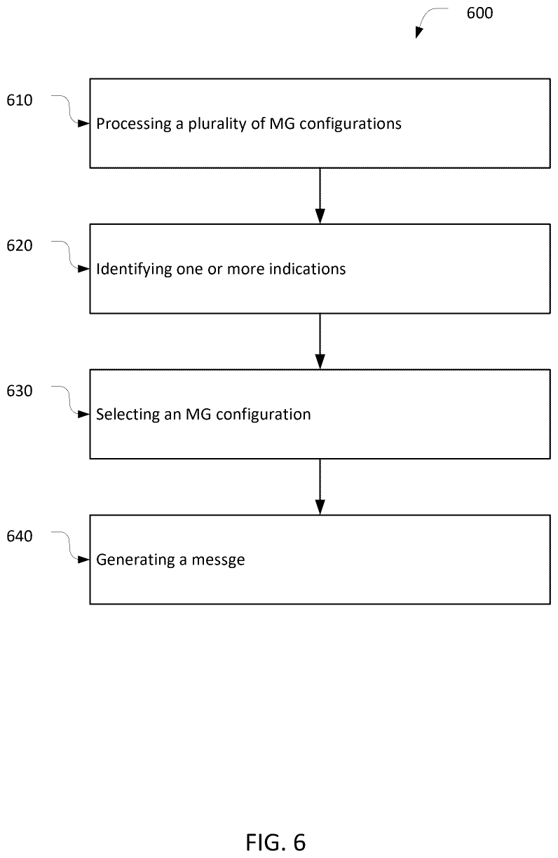

FIG. 6 illustrates an operation flow/algorithmic structure 600 in accordance with some embodiments. The operation flow/algorithmic structure 600 may be performed or implemented by a UE such as, for example, the UE 104 or UE 900; or components thereof, for example, baseband processor circuitry 904A.

The operation flow/algorithmic structure 600 may include, at 610, processing a plurality of measurement gap configurations. UE 104 may receive and process a plurality of measurement gaps from network 102. Measurement gap configurations may include an index (e.g., measurement gap identifier) determining a measurement gap pattern, e.g., a preconfigured gap offset, gap periodicity, or gap duration. In some instances, each parameter may be configured by the network 102. In some instances, measurement gap configuration may include a measurement gap type, such as per UE gap, per Frequency Range (FR) gap, Network Controlled Small Gaps (NCSG), and per Measurement Gap (perMG). UE 104 may select the measurement gap configuration from the plurality of measurement gap configurations.

The operation flow/algorithmic structure 600 may include, at 620, identifying one or more indications. UE 104 may identify one or more indications associated with its operational conditions. Various parameters may reflect the UE's operational conditions and requirements. These parameters may include S-measurement, measurement object, measurement requirement, processing status of the UE 104, current service status of data to be transmitted or received from the UE 104, location or mobility status of UE 104, or DRX configuration.

The operation flow/algorithmic structure 600 may include, at 630, selecting a measurement gap configuration. UE 104 may select the measurement gap configuration from the plurality of configured measurement gap configurations.

The operation flow/algorithmic structure 600 may include, at 640, generating a message. The generated message may be output for transmission to network 102 to indicate activation of the selected measurement gap configuration. In some embodiments, the message may be included in a UCI, a MAC CE, or an RRC message.

The message may include an indication of an index of the MG configuration; a measurement object associated with the MG configuration; a scheduling restriction pattern associated with the MG configuration; a start time of a measurement period associated with the MG configuration; a stop time of a measurement period associated with the MG configuration; a duration of a measurement period associated with the MG configuration; or a periodicity of a measurement period associated with the MG configuration.

In some embodiments, UE 104 or components thereof may determine that a DRX-OFF period may be used to perform a measurement. Based on such determination, UE 104 may generate a message to indicate the deactivation of the measurement gap and send it to the network 102.

In some embodiments, UE 104 or components thereof may generate and output its preferred measurement gap configurations for transmission to network 102. The indications of the preferred MG configurations may be generated using RRC, MAC CE, or UCI.

In some embodiments, UE 104 or components thereof may identify a collision between a measurement operation and a non-measurement operation during a measurement gap occasion associated with a measurement gap configuration. UE 104 or components thereof may apply a priority rule to determine whether to perform the measurement or non-measurement operations.

In one example, the non-measurement operation may be the transmission of one or more data packets. Prioritization rule may include determining whether one or more data packets are critical packets and prioritizing critical packets over measurement operations.

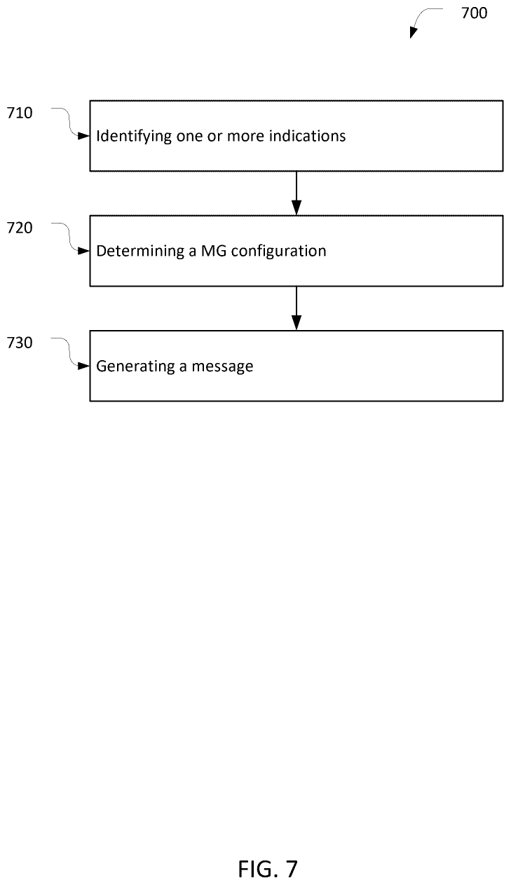

FIG. 7 illustrates an operational flow/algorithmic structure 700 in accordance with some embodiments. The operation flow/algorithmic structure 700 may be performed or implemented by a UE such as, for example, the UE 104 or UE 900; or components thereof, for example, baseband processor circuitry 904A.

The operation flow/algorithmic structure 700 may include, at 710, identifying one or more indications. UE 104 or components thereof may identify one or more indications associated with its operational conditions. Various parameters may reflect the UE's operational conditions and requirements. These parameters may include S-measurement, measurement object, measurement requirement, processing status of the UE 104, current service status of data to be transmitted or received from the UE 104, location or mobility status of UE 104, or DRX configuration.

The operation flow/algorithmic structure 700 may include, at 720, determining a measurement gap configuration. UE 104 or components thereof may autonomously determine the measurement gap configuration. Measurement gap configurations may include an index (e.g., measurement gap identifier) determining a measurement gap pattern, e.g., a preconfigured gap offset, gap periodicity, or gap duration. In some instances, each parameter may be configured by the network 102. In some instances, measurement gap configuration may include a measurement gap type, such as per UE gap, per Frequency Range (FR) gap, Network Controlled Small Gaps (NCSG), and per Measurement Gap (perMG). UE 104 may select the measurement gap configuration from the plurality of measurement gap configurations.

The operation flow/algorithmic structure 700 may include, at 730, generating a message. UE 102 or components thereof may generate a message and output the message for transmission to network 102 to indicate activation of the selected measurement gap configuration. In some embodiments, the message may be included in a UCI, a MAC CE, or an RRC message.

The message may include an indication of an index of the MG configuration; a measurement object associated with the MG configuration; a scheduling restriction pattern associated with the MG configuration; a start time of a measurement period associated with the MG configuration; a stop time of a measurement period associated with the MG configuration; a duration of a measurement period associated with the MG configuration; or a periodicity of a measurement period associated with the MG configuration.

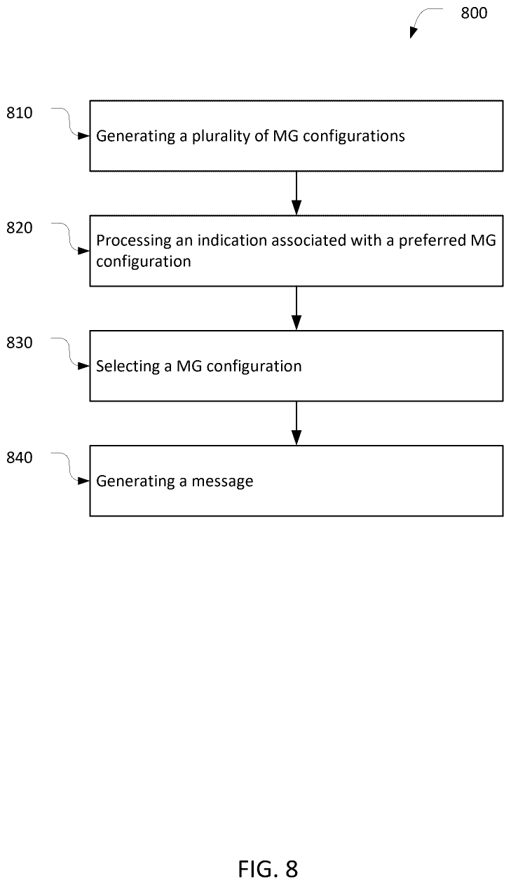

FIG. 8 illustrates an operational flow/algorithmic structure 800 in accordance with some embodiments. The operation flow/algorithmic structure 800 may be performed or implemented by a base station such as, for example, the base station 108 or the base station 1000; or components thereof, for example, baseband processor circuitry 1004A.

The operation flow/algorithmic structure 800 may include, at 810, generating a plurality of measurement gap configurations. Network 102 may generate and transmit a plurality of measurement gaps to UE 104. Measurement gap configurations may include an index (e.g., measurement gap configuration identifier) determining a measurement gap pattern, e.g., a preconfigured gap offset, gap periodicity, or gap duration. In some instances, each parameter may be configured by the network 102. In some instances, measurement gap configuration may include a measurement gap type, such as per UE gap, per Frequency Range (FR) gap, Network Controlled Small Gaps (NCSG), and per Measurement Gap (perMG). UE 104 may select the measurement gap configuration from the plurality of measurement gap configurations.

The operation flow/algorithmic structure 800 may include, at 820, processing an indication. Network 102 may receive and process an indication from UE 104. The indication may be associated with a preferred measurement gap configuration of UE 104. In some instances, the indication may include a measurement gap configuration identifier. In some instances, the indication may include a preferred measurement gap configuration, e.g., including a measurement gap type, length, offset, or periodicity.

The operation flow/algorithmic structure 800 may include, at 830, selecting a measurement gap configuration. Network 102 may select a measurement gap configuration. In some embodiments, the selected measurement gap may be based on the preferred measurement gap configuration of UE 104. In some embodiments, the selected measurement gap is from the plurality of measurement gaps.

The operation flow/algorithmic structure 800 may include, at 840, generating a message. The generated message may be output for transmission to UE 104 to indicate activation of the selected measurement gap configuration. In some embodiments, the message may be included in a DCI, a MAC CE, or an RRC message.

The message may include an indication of an index of the MG configuration; a measurement object associated with the MG configuration; a scheduling restriction pattern associated with the MG configuration; a start time of a measurement period associated with the MG configuration; a stop time of a measurement period associated with the MG configuration; a duration of a measurement period associated with the MG configuration; or a periodicity of a measurement period associated with the MG configuration.

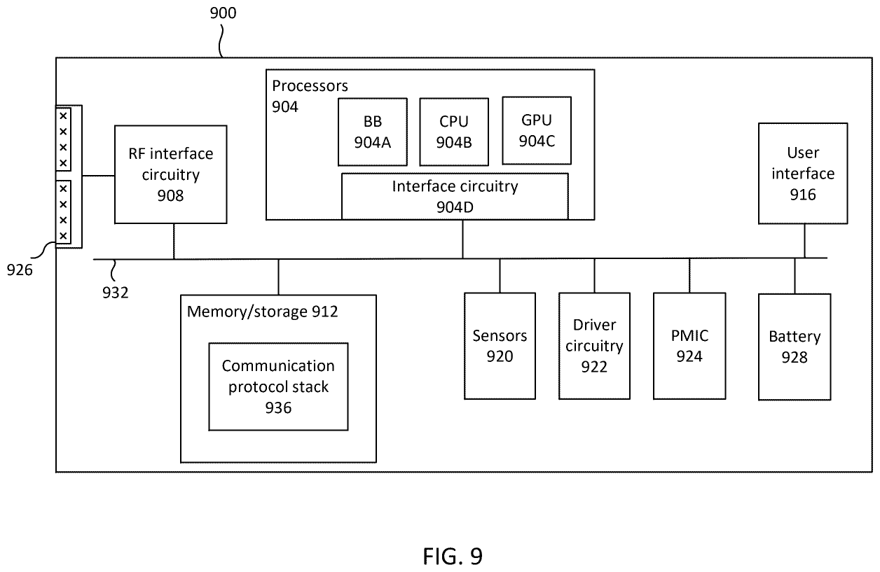

FIG. 9 illustrates a UE 900 in accordance with some embodiments. The UE 900 may be similar to and substantially interchangeable with the UE 104.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein. The processors 904 may also include interface circuitry 904D to enable communication by, for example, communicatively coupling the processor circuitry with one or more other components of the UE 900.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein.

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor circuitry 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within or connected to the UE 900. For example, driver circuitry 922 may include a display driver to control and allow access to a display device, a touchscreen driver to control and allow access to a touchscreen interface, sensor drivers to obtain sensor readings of sensors 920, and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples, the UE 900 may be mounted deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

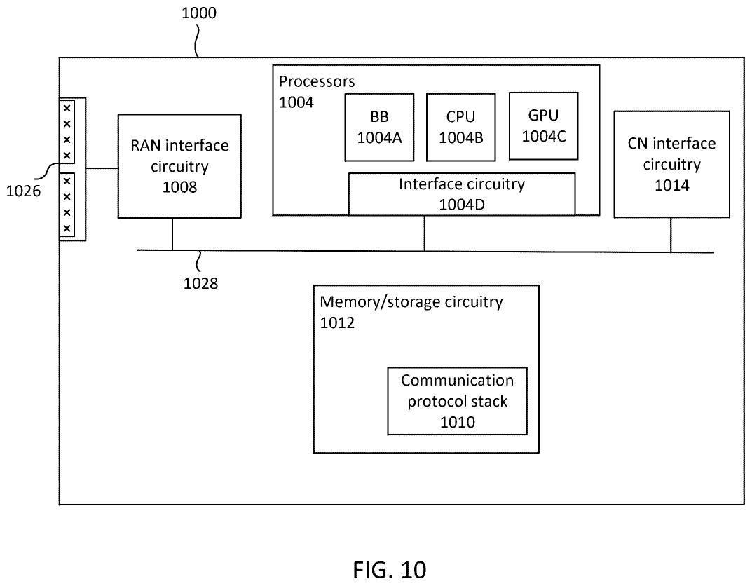

FIG. 10 illustrates a network device 1000 in accordance with some embodiments. The network device 1000 may be similar to and substantially interchangeable with base station 108.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the UE 900 to perform operations as described herein. The processors 1004 may also include interface circuitry 1004D to communicatively couple the processor circuitry with one or more other components of the network device 1000.

The CN interface circuitry 1014 may provide connectivity to a core network, for example, a 5th Generation Core network (5GC) using a 5GC-compatible network interface protocol such as carrier Ethernet protocols or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: processing a plurality of measurement gap (MG) configurations received from a network; identifying one or more parameters associated with an operational condition of a user equipment; selecting, based on the one or more parameters, an MG configuration from the plurality of MG configurations for activation; and generating a message to be transmitted to the network, the message to indicate activation of the MG configuration.

Example 2 includes the method of example 1 or some other examples herein, wherein the one or more parameters include: a serving cell reference signal received power (RSRP) measurement (S-measurement); a measurement object; a measurement requirement; a processing status of a user equipment; a current service status of data to be transmitted or received from a user equipment; a location or mobility status of a user equipment; or a discontinuous reception (DRX) configuration.

Example 3 includes the method of examples 1 or 2 or some other examples herein, wherein the message includes an indication of: an index of the MG configuration; a measurement object associated with the MG configuration; a scheduling restriction pattern associated with the MG configuration; a start time of a measurement period associated with the MG configuration; a stop time of a measurement period associated with the MG configuration; a duration of a measurement period associated with the MG configuration; or a periodicity of a measurement period associated with the MG configuration.

Example 4 includes the method of any of examples 1-3 or some other examples herein, wherein the message is an uplink control information (UCI) transmission, a medium access control (MAC) control element (CE), or a radio resource control (RRC) message.

Example 5 includes the method of any of examples 1-4 or some other examples herein, wherein individual MG configurations of the plurality of MG configurations include a measurement gap configuration identifier (ID) or a gap type.

Example 6 includes the method of any of examples 1-5 or some other examples herein, further including: determining that a discontinuous reception (DRX)-OFF period can be used to perform a measurement; and generating, based on said determining that a DRX-OFF period can be used to perform a measurement, a transmission to be transmitted to a base station to indicate deactivating the MG.

Example 7 includes the method of any of examples 1-6 or some other examples herein, further including: generating an indication associated with a preferred MG configuration.

Example 8 includes the method of any of examples 1-7 or some other examples herein, further including: identifying a collision between a measurement operation and a non-measurement operation during a MG associated with the MG configuration; determining a priority of the measurement operation and a priority of the non-measurement operation; performing a prioritization, based on the priority of the measurement operation and the priority of the non-measurement operation, to select an operation from the measurement operation and the non-measurement operation; and performing the operation during the MG.

Example 9 includes the method of any of examples 1-8 or some other examples herein, further including: processing a preemption rule received from a base station, wherein said performing a prioritization is further based on the preemption rule.

Example 10 includes the method of any of examples 1-11 or some other examples herein, wherein the measurement operation comprises a measurement of a neighbor cell during the MG of the neighbor cell and the non-measurement operation is a transmission of one or more critical packets, and performing a prioritization includes: prioritizing the transmission of the one or more critical packets over the MG of the neighbor cell.

Example 11 includes the method of any of examples 1-10 or some other examples herein, further including: performing the measurement of the neighbor cell on a frequency without a configured or activated measurement gap.

Example 12 includes the method of any of examples 1-11 or some other examples herein, further including: identifying a collision between a measurement operation and a non-measurement operation during a MG associated with the MG configuration; performing the measurement operation in a first portion of the MG; and performing the non-measurement operation in a second portion of the MG, wherein the first portion does not overlap with the second portion.

Example 13 includes the method of any of examples 1-12 or some other examples herein, wherein performing the non-measurement operation in the second portion of the MG is based on a UE capability or a confidence level of completing the measurement operation within the first portion of the MG.

Example 14 includes the method of any of examples 1-13 or some other examples herein, wherein the MG configuration defines one or more measurement occasions, and the method further includes: selecting a subset of the one or more MG occasions.

Example 15 includes the method of any of examples 1-14 or some other examples herein, wherein the message indicates the subset.

Example 16 includes a method including: identifying one or more indications associated with an operational condition of a user equipment; selecting, based on the one or more indications, a measurement gap (MG) configuration; and generating a message to be transmitted to a network, the message to indicate activation of the MG configuration.

Example 17 includes the method of example 16 or some other examples herein, wherein the message includes a measurement gap identifier (ID) associated with a predefined MG configuration.

Example 18 includes the method of examples 16 or 17 or some other examples herein, wherein the MG configuration includes a gap pattern.

Example 19 includes the method of any of examples 16-18 or some other examples herein, wherein the MG configuration is a first MG configuration and the method further includes: processing a plurality of MG configurations received from a network; and switching from the first MG configuration to a second MG configuration, wherein the second MG configuration is from the plurality of MG configurations.

Example 20 includes a method including: generating a plurality of measurement gap (MG) configurations to be transmitted to a user equipment (UE); processing an indication associated with a preferred MG configuration, wherein the indication is received from the UE; selecting, based on the indication, a MG configuration from the plurality of MG configuration for activation; and generating a message to be transmitted to the UE, the message to indicate activation of the MG configuration.

Example 21 includes the method of example 20 or some other examples herein, wherein the message is a radio resource control (RRC) signaling, a medium access control (MAC) control element (CE), or a downlink control information (DCI)

Another example may include an apparatus comprising means to perform one or more elements of a method described in or related to any of examples 1-21, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example may include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a plurality of measurement gap (MG) configurations received from a network;
identifying at least one parameter associated with an operational condition of a user equipment (UE);
selecting, based on the at least one parameter, a first MG configuration from the plurality of MG configurations for activation; and
generating a message to be transmitted to the network, the message to indicate activation of the first MG configuration.

2. The method of claim 1, wherein the at least one parameter includes at least one of:
a serving cell reference signal received power (RSRP) measurement;
a measurement object;
a measurement requirement;
a processing status of the UE;
a current service status of data to be transmitted or received from the UE;
a location or a mobility status of the UE; or
a discontinuous reception (DRX) configuration.

3. The method of claim 1, wherein the message includes an indication of:
an index of the first MG configuration;
a measurement object associated with the first MG configuration;
a scheduling restriction pattern associated with the first MG configuration;
a start time of a measurement period associated with the first MG configuration;
a stop time of a measurement period associated with the first MG configuration;
a duration of a measurement period associated with the first MG configuration; or
a periodicity of a measurement period associated with the first MG configuration.

4. The method of claim 1, wherein the message is an uplink control information (UCI), a medium access control (MAC) control element (CE), or a radio resource control (RRC) message.

5. The method of claim 1, wherein individual MG configurations of the plurality of MG configurations include a measurement gap configuration identifier (ID) or a gap type.

6. The method of claim 1, further comprising:
determining that a discontinuous reception (DRX)-OFF period can be used to perform a measurement; and
generating, based on said determining that the DRX-OFF period can be used to perform the measurement, a message to be transmitted to the network to indicate deactivation of the MG.

7. The method of claim 1, further comprising:
generating, for transmission to the network, an indication of a preferred MG configuration.

8. The method of claim 1, further comprising:
identifying a collision between a measurement operation and a non-measurement operation during a MG associated with the first MG configuration;
determining a relative priority between the measurement operation and the non-measurement operation;
selecting, based on the relative priority, an operation from the measurement operation and the non-measurement operation; and
performing the selected operation during the MG.

9. The method of claim 8, further comprising:
processing a preemption rule received from a base station, wherein said determining the relative priority is based on the preemption rule.

10. The method of claim 8, wherein the measurement operation includes a measurement of a neighbor cell during the MG of the neighbor cell and the non-measurement operation includes a transmission of at least one critical packet, and said determining the relative priority includes:
prioritizing the transmission of the at least one critical packet over the measurement of the neighbor cell.

11. The method of claim 10, further comprising:
performing the measurement of the neighbor cell on a frequency without a configured or activated measurement gap.

12. The method of claim 1, further comprising:
identifying a collision between a measurement operation and a non-measurement operation during a MG associated with the first MG configuration;
performing the measurement operation in a first portion of the MG; and
performing the non-measurement operation in a second portion of the MG, wherein the first portion does not overlap with the second portion.

13. The method of claim 12, wherein performing the non-measurement operation in the second portion of the MG is based on a UE capability or a confidence level of completing the measurement operation within the first portion of the MG.

14. The method of claim 1, wherein the first MG configuration defines a plurality of MG occasions, and the method further comprises:
selecting a subset of the plurality of MG occasions during which to perform respective measurements, wherein the message indicates the subset.

15. An apparatus comprising:
processor circuitry to:
identify at least one operational condition of a user equipment (UE);
select, based on the at least one operational condition, a measurement gap (MG) configuration; and
generate a message to be transmitted to a network, the message to indicate activation of the MG configuration; and
interface circuitry coupled to the processor circuitry to enable communication.

16. The apparatus of claim 15, wherein the MG configuration is selected from among a plurality of predefined MG configurations, and wherein the message includes a measurement gap identifier (ID) associated with the selected MG configuration.

17. The apparatus of claim 15, wherein the at least one operational condition includes at least one of:
a serving cell reference signal received power (RSRP) measurement;
a measurement object;
a measurement requirement;
a processing status of the UE;
a current service status of data to be transmitted or received from the UE;
a location or a mobility status of the UE; or
a discontinuous reception (DRX) configuration.

18. The apparatus of claim 15, wherein the MG configuration is a first MG configuration and the processor circuitry is further to:
process a plurality of MG configurations received from the network, the plurality of MG configurations including the first MG configuration; and
switch from the first MG configuration to a second MG configuration of the plurality of MG configurations.

19. A method comprising:
generating a plurality of measurement gap (MG) configurations to be transmitted to a user equipment (UE);
processing an indication, received from the UE, to indicate a preferred MG configuration;
selecting, based on the indication, a MG configuration from the plurality of MG configuration for activation; and
generating, for transmission to the UE, a message to indicate activation of the MG configuration.

20. The method of claim 19, wherein the message is a radio resource control (RRC) message, a medium access control (MAC) control element (CE), or a downlink control information (DCI).
